(19) United States
(12) Patent Application Publication
(10) Pub. No.: US 2026/0358635 A1
(43) Pub. Date: Nov. 12, 2026

(54) A HEADS-UP DISPLAY (HUD) SYSTEM FOR A VEHICLE

(71) Applicant: Continental Automotive Technologies GmbH, Hannover (DE)

(72) Inventors: Sean Boo Siong LIM, Singapore (SG); Boon Chong LIM, Singapore (SG)

(73) Assignee: Continental Automotive Technologies GmbH, Hannover (DE)

(21) Appl. No.: 19/134,913

(22) PCT Filed: Nov. 29, 2023
(86) PCT No.: PCT/EP2023/083475

§ 371 Date: Jun. 2, 2025

(30) Foreign Application Priority Data
Dec. 1, 2022 (GB) 2218046.7

(51) Int. Cl. G02B 27/01

(52) U.S. Cl. CPC G02B 27/0172

(57) ABSTRACT

A heads-up display (HUD) system for a vehicle is disclosed. The HUD system includes a picture generation unit (PGU) including an illumination source configured to illuminate light and an optical assembly which includes a beam splitter to split incident light into a first polarized section and a second polarized section. The second polarized section passes through a waveplate. The projection unit further includes a first diffuser and lens assembly and second diffuser and lens assembly configured to receive one of the first polarized section and the second polarized section. The HUD system further includes a projection unit and a display unit positioned to receive the first polarized section and the second polarized section through the first diffuser and lens assembly and second diffuser and lens assembly and transmit onto a glass of the vehicle.

### CROSS REFERENCE TO RELATED APPLICATIONS

This application is the U.S. National Phase application of PCT International Application No. PCT/EP2023/083475, filed Nov. 29, 2023, which claims priority to GB Patent Application No. 2218046.7, filed Dec. 1, 2022, the contents of such applications being incorporated by reference herein.

### TECHNICAL FIELD

Present invention relates in general to a field of automobiles and more in particular, the present invention relates to a heads-up display (HUD) of a vehicle.

### BACKGROUND

A HUD unit is a system that displays various items of information on a see-through display, such as driving information of the vehicle or navigation information, on the windshield of the vehicle within the main view of the driver while the vehicle is in motion. Typically there are two types of HUD systems, either in a stowaway form which are hidden from view and stowed underneath a cockpit area when not in use, or windshield-type, which projects the information for driver's viewing onto a windshield of a motor vehicle.

One of the main challenge of HUD system is space constrains within a cockpit of a motor vehicle, thus automotive makers are moving towards producing more compact sized HUD systems.

The present disclosure has been devised in the light of the above considerations.

### SUMMARY OF THE INVENTION

One or more shortcomings of the conventional systems and methods are overcome, and additional advantages are provided through the provision of the system and method as claimed in the present disclosure.

Additional features and advantages are realized through the techniques of the present disclosure. Other embodiments and aspects of the disclosure are described in detail herein and are considered a part of the claimed disclosure.

In one non-limiting embodiment of the disclosure, a heads-up display (HUD) system for a vehicle is disclosed. The HUD system comprises a picture generation unit (PGU) comprising an illumination source configured to illuminate light and an optical assembly. The optical assembly includes a beam splitter configured to split incident light from the illumination source into a first polarized section and a second polarized section. The first polarized section is transmitted through the beam splitter and the second polarized section is reflected from the beam splitter. The second polarized section passes through a waveplate. The optical assembly further includes a first diffuser and lens assembly configured to receive one of the first polarized section and the second polarized section and there is a second diffuser and lens assembly configured to receive remaining of the first polarized section and the second polarized section. There is a projection unit installed at a light emitting side of the illumination source. The HUD system further comprises a display unit positioned to receive the first polarized section and the second polarized section through the first diffuser and lens assembly and second diffuser and lens assembly and transmit onto a glass of the vehicle.

In an embodiment of the disclosure, the HUD system comprises a mirror to further reflect at least one of the first polarized section and the second polarized section on to at least one of the first diffuser and lens assembly and the second diffuser and lens assembly.

In an embodiment of the disclosure, the display unit transmits the first polarized section and the second polarized section as a first illumination cone and a second illumination cone created by the first diffuser and lens assembly and the second diffuser and lens assembly on the glass of the vehicle. The first illumination cone is configured to project a first information on a first zone of the glass of the vehicle and the second illumination cone is configured to project a second information on a second zone of the glass of the vehicle.

In an embodiment of the disclosure, the glass of the vehicle is a windshield.

In an embodiment of the disclosure, the first zone and the second zone are adjacent portions of the glass.

In an embodiment of the disclosure, the illumination source includes a plurality of light emitting diodes (LEDs) and collimators. The illumination source is positioned to illuminate light from a rear end or from a side of the HUD system.

In an embodiment of the disclosure, the waveplate is provisioned in a plane parallel to plane of position of the first diffuser and lens assembly and the second diffuser and lens assembly. The waveplate is provisioned adjacent to one of the first diffuser and lens assembly or the second diffuser and lens assembly based on the position of the illumination source.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING FIGURES

The novel features and characteristic of the disclosure are set forth in the appended claims. The disclosure itself, however, as well as a preferred mode of use, further aspects, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a schematic view of a heads-up display (HUD) system for a vehicle, in accordance with an embodiment of the present disclosure.

FIG. 2A illustrates a schematic view of a portion of the heads-up display (HUD) system with different components of an optical assembly of a picture generation unit (PGU) to project light on to a display unit, in accordance with an embodiment of the present disclosure.

FIG. 2B illustrates a schematic view of a portion of the heads-up display (HUD) system with different components of the optical assembly of the PGU to project light on to the display unit in an alternate position of an illumination source, in accordance with an embodiment of the present disclosure.

The figure depicts embodiments of the disclosure for purposes of illustration only. One skilled in the art will readily recognize from the following description that alternative embodiments of the heads-up display (HUD) system may be employed without departing from the principles of the disclosure described herein.

### DETAILED DESCRIPTION

The foregoing has broadly outlined the features and technical advantages of the present disclosure in order that the description of the disclosure that follows may be better understood. Additional features and advantages of the disclosure will be described hereinafter which form the subject of the disclosure. It should be appreciated by those skilled in the art that the conception and specific embodiments disclosed may be readily utilized as a basis for modifying or designing other system for carrying out the same purposes of the present disclosure. It should also be realized by those skilled in the art that such equivalent constructions do not depart from the scope of the disclosure. The novel features which are believed to be characteristic of the disclosure, as to its organization, together with further aspects and advantages will be better understood from the following description when considered in connection with the accompanying figures. It is to be expressly understood, however, that each of the figures is provided for the purpose of illustration and description only and is not intended as a definition of the limits of the present disclosure.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described below. It should be understood, however that it is not intended to limit the disclosure to the particular forms disclosed, but on the contrary, the disclosure is to cover all modifications, equivalents, and alternatives falling within the scope of the disclosure.

The terms “comprises . . . a”, “comprising”, or any other variations thereof, are intended to cover a non-exclusive inclusion, such that a system that comprises a list of components does not include only those components but may include other components not expressly listed or inherent to such mechanism. In other words, one or more elements in the system or steps of method proceeded by “comprises . . . a” does not, without more constraints, preclude the existence of other elements or additional elements in the device.

It is to be noted that a person skilled in the art would be motivated from the present disclosure and modify various features of device and system, without departing from the scope of the disclosure. Therefore, such modifications are considered to be part of the disclosure. Accordingly, the drawings show only those specific details that are pertinent to understand the embodiments of the present disclosure, so as not to obscure the disclosure with details that will be readily apparent to those of ordinary skilled in the art having benefit of the description herein. Also, the device and system of the present disclosure may be employed in any kind of vehicles such as passenger vehicles and commercial vehicles. However, complete vehicle and HUD system are not illustrated in the drawings of the disclosure for the purpose of simplicity.

The term “heads-up display (HUD)” in the present disclosure is used to refer to a unit or a system that displays various items of information, such as driving information of the vehicle or navigation information, on the glass or windshield of the vehicle within the main view of the driver while the vehicle is in motion. The term “substantially” herein in the present disclosure is used to mean that a feature or component significantly or considerably varies in size with respect to other feature or component. The term “wider” in the present disclosure is used to compare width dimension of one feature or component to another. The term “projection” in the present disclosure is used to refer to presentation of information or images. The terms “first” and “second” element may be used interchangeably herein.

The following detailed description is merely exemplary in nature and is not intended to limit application and uses. Furthermore, there is no intention to be bound by any theory presented in the preceding background or summary or the following detailed description.

Hereinafter, preferred embodiments of the present disclosure will be described referring to the accompanying drawings.

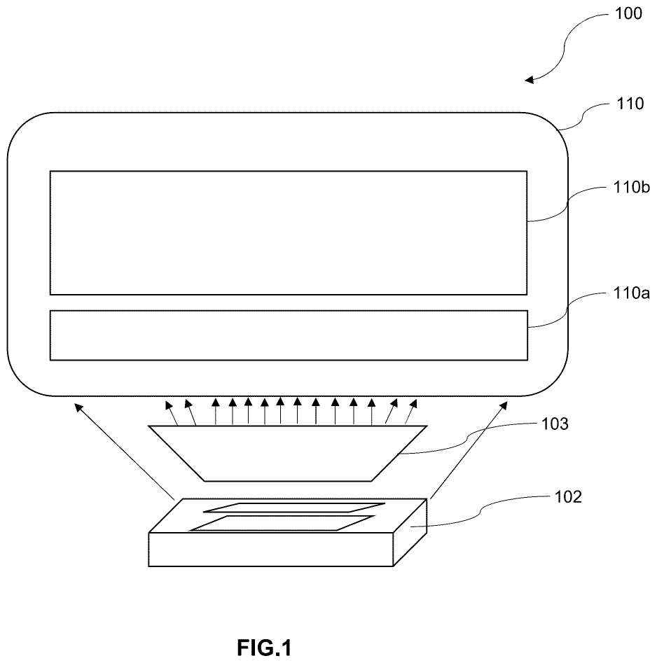

FIG. 1 illustrates a schematic view of heads-up display HUD system 100 of a vehicle. The HUD system 100 according to some embodiments of the present disclosure is a two-layer HUD. The two-layer HUD may be configured to display two different sets of information. Such two-layer HUD may typically include two zones 110a and 110b on a windshield 110, where each zone may display separate information. Although the present disclosure is disclosed using two-layer HUD, the same should not be considered as a limitation of the present disclosure, as there may be more than two-layers or less than two-layers adopted with minor modifications in the HUD system 100 of the present disclosure. Additionally, the two zones 110a and 110b may be positioned one above the other or next to each other sideways. However, such arrangement of two zones 110a and 110b should not be considered as a limitation to the present disclosure.

As shown in FIG. 1, the HUD system 100 of the present disclosure includes a picture generation unit (PGU) 102 which further includes an illumination source 112 having a plurality of light emitting diodes (LEDs) and collimators and an optical assembly. In an embodiment, the illumination source 112 may be an array of light sources for emitting beams of light. The light rays are indicated by arrows in FIG. 1. Further, the HUD system 100 also includes a projection unit 103. The projection unit (103) may be provisioned at light emitting side of the illumination source 112. The projection unit 103 is configured to receive the light emitted from the illumination source 112 and project information on to a glass 110 of the vehicle. The projection onto the glass 110 is also indicated by arrows. In an embodiment, the glass 110 of the vehicle may be a windshield of the vehicle i.e., the information may be projected on the windshield 110 of the vehicle.

The glass 110 or windshield of the vehicle may include two zones i.e., a first zone 110a and a second zone 110b. The two zones may be configured to display two separate information. In an embodiment, the information displayed on the windshield 110 may include speed, warning signals, indicator arrows for navigation, virtual images, and exterior view of the traffic conditions. However, the type of information displayed on the glass 110, or windshield should not be considered as a limitation of the present disclosure.

In an embodiment, the first zone 110a and the second zone 110b may be positioned one below the other. In an embodiment, the first zone 110a and the second zone 110b may be adjacent to each other sideways. The first zone 110a may be smaller in size, and the second zone 110b may be bigger in size. Accordingly, the first zone 110a may display information that requires lesser space as compared to the second zone 110b.

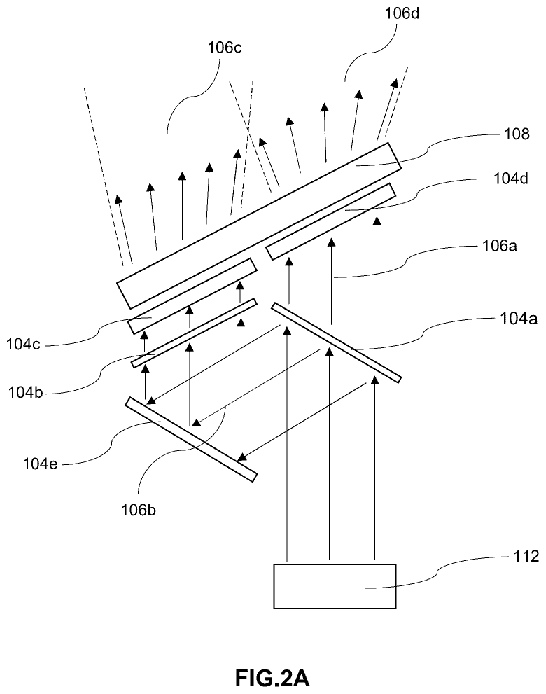

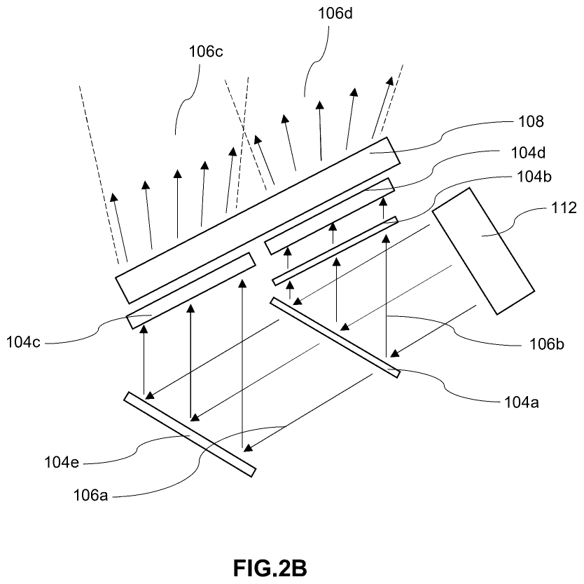

Referring now to FIG. 2A and FIG. 2B in conjunction, they depict schematic views of the HUD system 100 of the present disclosure with different components of the optical assembly of the PGU 102. FIG. 2A shows the illumination source 112 positioned at a rear end of the HUD system 100, while FIG. 2B shows the illumination source 112 at a side of the HUD system 100. In an embodiment, for a two-layer HUD, generally large display, or projection unit 103 may be necessary in order to project information on both the zones 110a and 110b. Instead of an equivalent large illumination source 112, in the present disclosure, components or optical assembly of the PGU 102 allows fewer light sources such as light emitting diodes LEDs to be used.

The optical assembly of the PGU 102 may include a beam splitter 104a onto which the illumination source 102 illuminates light. In an embodiment, the beam splitter 104a is a polarized beam splitter, however for simplicity the term beam splitter is used herein. In an embodiment, the illumination source 112 may illuminate unpolarized light on the beam splitter 104a. The beam splitter 104a splits the incident light from the illumination source 102 into a first polarized section 106a and a second polarized section 106b. The first polarized section 106a may be transmitted through beam splitter 104a and the second polarized section 106b may be reflected portion from the beam splitter 104a. The first polarized section 106a is p-polarized light and the second polarized section 106b is s-polarized light. In an embodiment, the beam splitter 104a allows fewer LEDs to be used in the illumination source 112 and thus resulting in a more compact backlight to be used. This also means that there will be lesser heat generation.

As shown in FIG. 2A when back illuminating is used in terms of the illumination source 112, the second polarized section 106b or s-polarized light reflected from the beam splitter 104a is further reflected by a mirror 104e towards a waveplate 104b or a retarder. The waveplate 104b rotates the second polarized section 106b or the s-polarized light into p-polarized light. The p-polarized light is further transmitted towards a first diffuser and lens assembly 104c. Meanwhile, the first polarized section 106a or p-polarized light transmitted through the beam splitter 104a may be projected on to a second diffuser and lens assembly 104d. Thus, both the first diffuser and lens assembly 104c and the second diffuser and lens assembly 104d receive p-polarized light. In an embodiment, the waveplate 104b or the retarder which rotates the s-polarized light into p-polarized light ensures that light transmits through a display unit 108. In an embodiment, the waveplate 104b may be positioned in plane parallel to and adjacent to plane of the position of the first diffuser and lens assembly 104c as shown in FIG. 2B. Further, the display unit 108 receives the p-polarized light from the first diffuser and lens assembly 104c and the second diffuser and lens assembly 104d. In an embodiment, the display unit 108 may be a liquid crystal display LCD but is not limited to the same.

In an embodiment, as shown in FIG. 2A a first illuminating cone 106c and a second illuminating cone 106d may be formed by the second polarized section 106b and the first polarized section 106a respectively passing through the first diffuser and lens assembly 104c and the second diffuser and lens assembly 104d respectively. In an embodiment, both the first and second illuminating cones 106c and 106d may be s-polarized light. The first illuminating cone 106c and the second illuminating cone 106d may be configured to illuminate the glass 110 of the vehicle. In an embodiment, the first illuminating cone 106c may project first information on the first zone 110a the glass 110 and the second illuminating cone 106d may project second information on the second zone 110b of the glass 110 or the windshield of the vehicle. The illumination cones 106c and 106d may project information at same or different intensities on the glass 110 of the vehicle and the same should not be construed as a limitation of the present disclosure.

FIG. 2B shows the illumination source 112 positioned on a side. Here, the unpolarized light from the illumination source 112 is incident on the beam splitter 104a which splits it into the first polarized section 106a or p-polarized light that transmits through the beam splitter 104a on to the mirror 104e and the second polarized section 106b or s-polarized section on to the waveplate 104b or the retarder. In an embodiment, the waveplate 104b in this embodiment may be positioned in a plane adjacent to and parallel to the plane of the position of the second diffuser and lens assembly 104d. In an embodiment, the first polarized section 106a reflected from the mirror 104e may be projected on to the first diffuser and lens assembly 104c. Further, the first diffuser and lens assembly 104c and the second diffuser and lens assembly 104d may form the first illumination cone 106c and the second illumination cone 106d that transmits through the display unit 108 and project it on to the first zone 110a and the second zone 110b of the glass 110 or the windshield of the vehicle.

In an embodiment, the HUD system 100 of the present disclosure allows the first zone 110a and the second zone 110b of the glass 110 to be illuminated with first information and second information that may be useful for a user of the vehicle.

In an embodiment, the polarized beam splitter 104a of the projection unit 103 of the HUD system 100 of the present disclosure allows fewer LEDs to be used in the illumination source 112 and thus resulting in a more compact backlight to be used. This also means that there will be lesser heat generation

It is to be understood that a person of ordinary skill in the art may develop a system of similar configuration without deviating from the scope of the present disclosure. Such modifications and variations may be made without departing from the scope of the present invention. Therefore, it is intended that the present disclosure covers such modifications and variations provided they come within the ambit of the appended claims and their equivalents.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding the description may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated in the description.

### REFERRAL NUMERALS

| | Reference |
|---|---|
| Description | number |
| Heads-up display (HUD) system | 100 |
| Picture generation unit (PGU) | 102 |
| Projection unit | 103 |
| Beam splitter | 104a |
| Waveplate | 104b |
| First diffuser and lens assembly | 104c |
| Second diffuser and lens assembly | 104d |
| Mirror | 104e |
| First polarized section | 106a |
| Second polarized section | 106b |
| First illumination cone | 106c |
| Second illumination cone | 106d |
| Display unit | 108 |
| Glass/windshield of the vehicle | 110 |
| First zone of the glass | 110a |
| Second zone of the glass | 110b |
| Illumination source | 112 |

1. A heads-up display system for a vehicle, the HUD system comprising:
a picture generation unit comprising:
an illumination source configured to illuminate light;
wherein,
the HUD system further comprises:
an optical assembly comprising:
a beam splitter configured to split incident light from the illumination source into a first polarized section and a second polarized section, wherein the first polarized section is transmitted through the beam splitter and the second polarized section is reflected from the beam splitter, the second polarized section passes through a waveplate;
a first diffuser and lens assembly configured to receive one of the first polarized section and the second polarized section; and
a second diffuser and lens assembly configured to receive remaining of the first polarized section and the second polarized section; and
a projection unit provisioned at a light emitting side of the illumination source; and
a display unit positioned to receive the first polarized section and the second polarized section through the first diffuser and lens assembly and the second diffuser and lens assembly and transmit onto a glass of the vehicle.

2. The HUD system according to claim 1, further comprises a mirror to reflect at least one of the first polarized section and the second polarized section onto
at least one of the first diffuser and lens assembly; and
the second diffuser and lens assembly.

3. The HUD system according to claim 1, wherein the display unit transmits the first polarized section and the second polarized section as a first illumination cone and a second illumination cone created by the first diffuser and lens assembly and the second diffuser and lens assembly on the glass of the vehicle.

4. The HUD system according to claim 1, wherein the glass is a windshield.

5. The HUD system according to claim 3, wherein the first illumination cone is configured to project a first information on a first zone of the glass of the vehicle.

6. The HUD system according to claim 1, wherein the second illumination cone is configured to project a second information on a second zone of the glass of the vehicle.

7. The HUD system according to claim 1, wherein the first zone and the second zone are adjacent portions of the glass.

8. The HUD system according to claim 1, wherein the illumination source includes a plurality of light emitting diodes and collimators.

9. The HUD system according to claim 1, wherein the illumination source is positioned to illuminate light from a rear end or from a side of the HUD system.

10. The HUD system according to claim 1, wherein the waveplate is provisioned in a plane parallel to plane of position of the first diffuser and lens assembly and the second diffuser and lens assembly.

11. The HUD system according to claim 9, wherein the waveplate is provisioned adjacent to one of the first diffuser and lens assembly or the second diffuser and lens assembly based on the position of the illumination source.

12. A vehicle comprising the HUD system as defined in claim 1.

13. The HUD system according to claim 2, wherein the display unit transmits the first polarized section and the second polarized section as a first illumination cone and a second illumination cone created by the first diffuser and lens assembly and the second diffuser and lens assembly on the glass of the vehicle.

14. The HUD system according to claim 10, wherein the waveplate is provisioned adjacent to one of the first diffuser and lens assembly or the second diffuser and lens assembly based on the position of the illumination source.
